(19) United States
(12) Patent Application Publication
(10) Pub. No.: US 2015/0367563 A1
(43) Pub. Date: Dec. 24, 2015

(54) SUBSTRATE WITH PROTECTIVE POLYVINYL CHLORIDE SLEEVE

(71) Applicant: Shoreline Plastics, LLC, Jacksonville, FL (US)

(72) Inventors: Mark Porter, Jacksonville, FL (US); Stafford McCartney, Green Cove Springs, FL (US)

(21) Appl. No.: 14/746,912

(22) Filed: Jun. 23, 2015

Related U.S. Application Data
(63) Continuation-in-part of application No. 14/312,663, filed on Jun. 23, 2014.

(51) Int. Cl. B29C 65/66; F16L 9/133; B32B 27/30; B29C 47/00; B32B 1/08

(52) U.S. Cl. CPC B29C 65/665; B29C 47/0064; B29C 47/0023; B32B 1/08; B32B 27/304; F16L 9/133; B29K 2027/06

(57) ABSTRACT

The present invention provides a heat shrinkable protective coating for protecting a substrate from deleterious elements present in environments in which the substrates are deployed and methods and apparatus for manufacturing a heat shrinkable coating of suitable length and girth to coat a pylon substrate or building girder. Prior to shrinking, the extruded pipe is slid over a wooden pylon, dimensional lumber, railroad tie or other metal or wood substrate. Upon application of heat, the pipe will shrink to encapsulate the substrate in a hermetically sealed, durable membrane.

### CROSS-REFERENCE TO RELATED APPLICATION

This application claims priority as a continuation in part to U.S. NonProvisional patent application Ser. No. 14/312,663, filed Jun. 23, 2014, and titled “EXTRUDED HEAT SHRINK PROTECTIVE SEAMLESS PVC PILING SLEEVE AND METHOD”, the entire contents of which are incorporated herein by reference.

### FIELD OF THE INVENTION

The present invention relates generally to methods and apparatus for protecting elongated substrates, such as wood pylons, utility poles, railroad ties and steel beams and columns. More specifically, the present invention provides methods and apparatus for a heat shrinkable protective polyvinyl chloride sleeve over a substrate and a resultant protected substrate.

### BACKGROUND

Wood pylons and timbers used in marine applications have been subjected for centuries to the costly problem of marine growth and wood boring infestation. Similar problems plague terrestrial structures. Generally protection for such structures from the detrimental effect of harmful organisms is limited to surface treatments or impregnating the wood with chemical solutions to inhibit the attachment of the various infestations.

Other known attempts to protect substrates include wrapping a wood pylon in a flexible plastic sheet. A seam formed by overlapping edges is bonded closed, and the wrap is heated to shrink to a snug fit. The overlapping edges that form the seam comprise double the width of the material of the sheet. Consequently, the heat that is sufficient to shrink the wrap away from the seam is insufficient to shrink the double width seam. Thus, a gap may be formed at the seam that allows intrusion by water and marine organisms. Furthermore, shrinkage of the wrap exerts tensile and shear stresses at the seam. These stresses may compromise the integrity of the seam, causing further intrusion.

Another problem with prior art wraps is failure to bond sufficiently to an underlying substrate. In particular a wood pylon has inherent surface irregularities such that a high viscosity hot melt adhesive disposed between a wrap and a wood pylon requires considerable pressure to bond with the wrap to the wood pylon. Various techniques and devices for applying pressure while heating have been devised. However, these devices are costly and cumbersome and time consuming to use. Additionally, these devices are prone to applying pressure over targeted areas, with considerable pressure gradients between targeted areas and other areas. This can result in uneven and weak bonding, which increases risk of de-bonding (i.e., delamination) and formation of gaps that are vulnerable to intrusion.

Yet another problem with prior art is that known protective wraps may be limited to use with certain materials and shapes. A protective cover suitable for use with a variety of substrates and shapes, whether or not used in marine applications, is needed.

Heat shrinkable tubing has been known wherein a material may be expanded from a heat stable condition to a thermally unstable condition and returned to a heat stable condition with the application of an appropriate amount of thermal energy. Such tubing is generally used in conjunction with covering of wires and is commercially available. However, due to the nature of polyvinyl chloride, extrusion of such tubing is limited to diameters of two inches or less. Diameters greater than about two inches experience tears or thin areas that result in aneurisms when the tube is placed under stress. In addition, during the manufacturing process, a larger diameter PVC tube will collapse under its own weight while in a heated condition and destroy itself.

### SUMMARY OF THE INVENTION

Accordingly, the present invention provides a heat shrinkable protective coating for protecting a substrate from deleterious elements present in environments in which the substrates are deployed and methods and apparatus for manufacturing a heat shrinkable coating of suitable length and girth to coat a pylon substrate or building girder. More specifically, the present invention provides a heat shrinkable protective coating for protecting a curvilinear substrate with a cross section of generally two inches or greater in diameter, and in preferred embodiments a diameter of four inches or greater or an angular shaped substrate with a diagonal cross section of generally two inches or greater and preferred embodiments a diagonal of four inches or greater. The present invention also includes methods and apparatus for manufacturing said heat shrinkable coating. In some embodiments an end cap may also be deployed to further encapsulate the substrate or girder.

As discussed more fully below, in some exemplary implementations of the present invention, a continuously extruded seamless polyvinyl chloride (“PVC”) pipe is manufactured from a combination of a unique PVC compound and a specialized extrusion process is provided that enables the pipe to be expanded to a thermally unstable diameter about 100% larger that a heat stable state, wherein a manufactured PVC pipe will shrink to about 50% of its manufactured size when reheated to a specific temperature.

In some aspects of the present invention, a manufactured PVC pipe can be positioned surrounding a substrate, such as a wooden beam for a pylon, or other timber, tie, column or dimensional lumber. Upon application of heat, the pipe will shrink from a thermally unstable expanded diameter towards a thermally stable unexpanded diameter and thereby encapsulate the substrate with a hermetically sealed, robust membrane. This seamless impervious membrane will generally protect the substrate from environmental conditions and offset the ability of an internal wood boring or surface destroying organism to negatively interact with the wooden substrate.

In some embodiment, the shrinkable pipe has a continuous or intermittent coating of a heat sensitive adhesive applied to its inner wall after extrusion and expansion, so that when the PVC pipe is shrunken to assume a shape based upon a surface of the substrate, the adhesive creates a bond between the shrunken substrate and the PVC pipe. The substrate being encapsulated can be of suitable length for building materials, pylons, tapering or parallel, treated or untreated with a diameter of between about 4 inches up to about 24 inches, based in part upon a thickness of the tube, and dimensions of a relevant extrusion die and expansion mandrel.

A method of protecting a structure (e.g., a wood pylon, railroad tie, dimensional lumber or other wood or metal structure) according to principles of the invention entails encasing at least a portion of the substrate in a heat shrinkable seamless PVC pipe.

According to the present invention, a heat shrinkable pipe is produced by heating a PVC dry blend until a melt is formed. The blend may include a fungicide. The melt is extruded through a die to form a seamless PVC pipe having an outer surface, an inner surface and an unexpanded inner diameter greater than about four inches.

The extruded PVC pipe is cooled to a first temperature below a glass transition temperature for the PVC pipe. After cooling, the extruded PVC pipe is heated to a second temperature of at least about the glass transition temperature for the PVC pipe. After heating the extruded PVC pipe to the second temperature, the PVC pipe is expanded from the unexpanded thermally stable inner diameter to an expanded thermally unstable inner diameter. The unexpanded inner diameter is generally about one half (for example, from between about 25% to 75%) of the expanded inner diameter.

A maximum width of the substrate to be coated (for example, a maximum diameter of a curvilinear substrate or a maximum diagonal of an angular substrate) is between the unexpanded thermally stable inner diameter of the PVC pipe and a thermally unstable expanded inner diameter of the PVC pipe.

Optionally, after expansion, one or both of a sealant and an adhesive may be applied onto at least a portion of an inner surface of the PVC pipe. In some embodiments, a hot melt adhesive with a relatively low viscosity when melted (e.g., less than 15,000 centipoise) may be applied. In a further aspect, in some embodiment, a fungicide may be included in one or both an adhesive or a sealant. After expanding, the PVC pipe may be cooled to a second temperature below the glass transition temperature for the PVC pipe and the PVC pipe may be cut to a determined size.

The step of expanding the PVC pipe entails passing the PVC pipe over a mandrel having a first cylindrical section with a first mandrel diameter about equal to the unexpanded inner diameter, and a second cylindrical section with a second mandrel diameter about equal to the expanded inner diameter, and a conical frustum disposed between and coupling the first cylindrical section to the second cylindrical section. The conical frustum, first cylindrical section and second cylindrical section are concentric. The mandrel may also include several sizing discs, each having a disc diameter about equal to the expanded inner diameter. Each of the sizing discs is concentric with the second cylindrical section and spaced apart from each other and the second cylindrical section. A negative atmospheric pressure may be maintained around the outer perimeter of the pipe at the mandrel as the PVC pipe passes over it during expansion.

In another aspect, positive atmospheric pressure may be provided in the interior of the PVC pipe as the PVC pipe is heated. The positive atmospheric pressure may be provided via a pressurized gas, such as an inert gas, or air. An inert gas may include nitrogen. The pressure may be maintained within the PCV pipe via the use of plug inside the pipe that obstruct the flow of the atmospheric gas in the interior of the PVC pipe. In some preferred embodiments, the positive atmospheric pressure is between about 20 to 30 psi (pounds per square inch) and provide pressure against an inner surface of the PVC pipe in an outward direction.

A cut segment of pipe is slid over at least a portion of the substrate (e.g., pylon, tie or other timber).

In still another aspect of the present invention, the substrate may be lifted with a forklift, such as a forklift equipped with a cylindrical sleeve for holding the structure in a cantilever manner on the forks. A heat source heats the PVC pipe on the substrate until the temperature of the PVC pipe reaches the glass transition temperature for the PVC pipe, whereupon exposure to the heat shrinks the PVC pipe from the thermally unstable expanded inner diameter towards the thermally stable unexpanded inner diameter to a shape tightly following the surface of the substrate.

In those embodiments involving a hot melt adhesive, heating melts the adhesive and the shrinking action compresses the adhesive into the structure, thereby forming an intimate bond between the substrate, the adhesive and the inner surface of the PVC pipe. Afterwards, the PVC pipe is allowed to cool forming a PVC membrane of a shape closely following the surface topography of the underlying substrate. After cooling, the substrate encased with the PVC membrane may be deployed for use or further fitted with endcaps, such as PVC endcaps.

### BRIEF DESCRIPTION OF THE DRAWINGS

The foregoing and other aspects, objects, features and advantages of the invention will become better understood with reference to the following description, appended claims, and accompanying drawings, where:

FIG. 1 illustrates a high level block schematic of an exemplary system for extruding seamless heat shrinkable pipe according to some implementations of the present invention;

FIG. 1A illustrates a high level block diagram of the use of intermittent plugs interior to the PVC pipe during manufacture of the PVC pipe;

FIG. 2 illustrates a perspective view of an exemplary expander for a system according to principles of the invention; and

FIG. 3 illustrates a plan view of an exemplary expander for a system according to principles of the invention; and

FIG. 4 illustrates a section view of an exemplary hot melt adhesive applicator for a system according to principles of the invention;

FIG. 5 illustrates a flowchart for an exemplary method of producing a seamless heat shrinkable sleeve according to principles of the invention;

FIG. 6 illustrates a side view of an exemplary pylon holder for a forklift according to principles of the invention;

FIG. 7 illustrates a perspective view of an exemplary pylon holder for a forklift according to principles of the invention;

FIG. 8 illustrates a side view of an exemplary forklift with a pylon holder in a lowered position according to principles of the invention;

FIG. 9 illustrates a side view of an exemplary forklift with a pylon holder in a raised position according to principles of the invention; and

FIG. 10 illustrates a flowchart for an exemplary method of applying a seamless heat shrinkable sleeve to a pylon according to principles of the invention; and

FIG. 11 illustrates a perspective view of an exemplary extruded heat shrink protective seamless pylon sleeve according to principles of the invention; and

FIG. 12 illustrates a section view of an exemplary extruded heat shrink protective seamless pylon sleeve according to principles of the invention; and

FIG. 13 illustrates a profile view of an exemplary extruded heat shrink protective seamless pylon sleeve with a surrounded pylon and a gap between the pylon and sleeve according to principles of the invention; and

FIG. 14 illustrates a perspective view of an exemplary extruded heat shrink protective seamless pylon sleeve with a surrounded pylon and a gap between the pylon and sleeve according to principles of the invention; and

FIG. 15 illustrates a profile view of an exemplary extruded protective seamless pylon sleeve with a surrounded pylon and no gap between the pylon and sleeve because the sleeve had been shrunk by applying heat according to principles of the invention; and

FIG. 16 illustrates a perspective view of a heat shrink rectangular end cap for use with an exemplary extruded protective seamless pylon sleeve with a surrounded pylon according to principles of the invention;

FIG. 17 illustrates a perspective view of a heat shrink circular end cap for use with an exemplary extruded protective seamless pylon sleeve with a surrounded pylon according to principles of the invention;

FIG. 18 illustrates a profile of a curvilinear substrate cut away and an angular substrate in relation to an unexpanded thermally stable diameter of a PVC pipe and a thermally unstable expanded diameter of the PVC pipe; and

FIG. 19 illustrates a perspective of a frustum shaped substrate and first PVC pipe sleeve and a second PVC pipe sleeve and an overlap region of the first sleeve and a second sleeve.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

The present invention provides for a substrate with protective coating. The protective coating is functional to protect the substrate from exposure to deleterious elements present in environments in which the substrates may be deployed. The present invention also includes methods and apparatus for manufacturing the substrate coating in the form of a PVC pipe of suitable length and diameter to encapsulate a substrate, such as for example a wooden pylon, a timber or building girder. More specifically, the present invention provides a PVC pipe with a thermally unstable expanded diameter and a thermally stable unexpanded diameter that is heat shrinkable to protect a curvilinear substrate four inches or greater in diameter or an angular shaped substrate four inches with a diagonal of four inches or greater and methods and apparatus for manufacturing said heat shrinkable coating. In some embodiments an end cap may also be deployed to further encapsulate the substrate or girder.

To solve one or more of the problems set forth above, in some exemplary implementations of the present invention, a continuously extruded seamless polyvinyl chloride (“PVC”) pipe is manufactured from a combination of a unique PVC compound and a specialized extrusion process is provided that enables the PVC pipe to be expanded to a thermally unstable diameter about 100% larger that a thermally stable state diameter, wherein a manufactured PVC pipe may shrink to about 50% of its manufactured size when heated to a specific temperature.

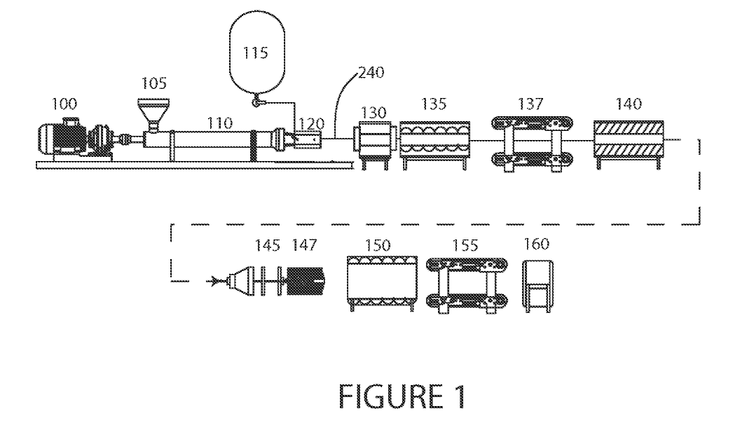

Referring now to FIG. 1, a high level schematic is illustrated of an exemplary system for extruding seamless heat shrinkable pipe according to principles of the invention. The dashed line illustrates an exemplary linear aligned progression of steps. Raw material comprising a dry blend of plastic polyvinyl chloride pellets and additional optional ingredients are introduced through a hopper 105 and extruded into a pipe sometimes referred to herein as a “PVC pipe” although additional components may be included.

A dry blend PVC compound to be extruded into heat shrinkable pipe may include components to both reflect and absorb ultra-violet rays, coloring pigments, process stabilizers, flexibility enhancers, surface migrating ablative fungicides/biocides and algaecides. A non-limiting example of an exemplary blend is provided below in Table 1. It is understood that various blends may in include all or some subset of the following listed components:

TABLE 1

| Parts* | Wt % | Material | Lbs |
|---|---|---|---|
| 100 | 78.25% | PVC Resin | 460.00 |
| 4 | 3.13% | Ultra-Violet Inhibitor | 18.40 |
| 5 | 3.91% | UFT Calcium Carbonate | 23.00 |
| 0.8 | 0.63% | Calcium Stearate | 3.68 |
| 1.2 | 0.94% | Paraffin Wax | 5.52 |
| 0.2 | 0.16% | Oxidized Polyethylene | 0.92 |
| 7 | 5.48% | Plasticizer | 32.20 |
| 0.02 | 0.02% | Marine Growth Inhibitor | 0.09 |
| 1.2 | 0.94% | Heat Stabilizer | 5.52 |
| 4 | 3.13% | Process Aid | 18.40 |
| 0.38 | 0.30% | Grey Color | 1.75 |
| 3 | 2.35% | Epoxidized Soy Bean Oil | 13.80 |
| 1 | 0.78% | Ultra-Violet Absorbative | 4.60 |
| 127.8 | 100.0% | TOTALS | 587.88 |

*Parts by weight per 100 parts of PVC resin

A motor 100 powers one or more screws of an extruder 110. The extruder heats the raw material supplied through a hopper 105, and forces the resulting melted polymer through an extrusion die 120. The molten polymer leaves the extruder die 120 in the form of one or more ribbons or molten streams.

Optionally, in some embodiments a heated receptacle 115 and gear pump may supply hot melt adhesive through a heat resistant (e.g., nylon) tube that passes through the die spider located in the mid region of the extruder die 120 and continues to connect through the sizing mandrel 145 and subsequently to the hot melt adhesive applicator 147 where the hot melt is evenly sprayed on the interior wall of the blown (i.e., expanded) pipe.

The extrusion die 120 supports and distributes the homogeneous polymer melt around a solid mandrel, which forms the homogeneous polymer melt into an annular shape for a solid wall pipe. The formed solid wall pipe is sometimes referred to herein as a “sleeve.” The formed pipe is seamless, though it may exhibit artifacts from the extrusion process.

The invention is not limited to PVC pipes with an adhesive applied to the inner surface. In embodiments having the adhesive, the invention is not limited to the applicator 125 described above. The adhesive may be co-extruded or applied in any other manner suitable for a continuous extrusion process.

Non-limiting examples of hot melt adhesives include ethylene-vinyl acetate copolymers; ethylene-acrylate copolymers, such as ethylene-vinylacetate-maleic anhydride and ethylene-acrylate-maleic anhydride terpolymers, ethylene n-butyl acrylate, ethylene-acrylic acid and ethylene-ethyl acetate; polyolefins, such as amorphous polyolefin polymers; polybutene-1 and its copolymers; polyamides; thermosetting polyurethanes; styrene copolymer adhesives and rubber-based adhesives, such as styrene-butadiene-styrene, styrene-isoprene-styrene, styrene-ethylene/butylene-styrene, and styrene-ethylene/propylene.

To adjust viscosity of the melt, tackifying resins and waxes may be added in varying amounts to the adhesive. Tackifying resins may include rosins and their derivates, terpenes and modified terpenes, aliphatic, cycloaliphatic and aromatic resins, hydrogenated hydrocarbon resins, and terpene-phenol resins. Waxes may include microcrystalline waxes, fatty amide waxes or oxidized Fischer-Tropsch waxes, which lower the melt viscosity and can improve bond strength and temperature resistance. A hot melt adhesive with a softening point of less than 250° F. and a viscosity at 350° F. of 15,000 centipoise or less is preferred. The adhesive melts during heat shrinking and flows freely into and bonds well with the substrate, without requiring pressure beyond the pressure exerted by the seamless shrinking pipe.

In a particular embodiment the adhesive is comprised of ethylene vinyl acetate (EVA) with a viscosity of about 10,500 centipoise at 350° F. The heat application used to shrink the pipe reactivates the EVA and provides a strong but flexible bond between the substrate and the PVC pipe.

The dimensions and heat shrink properties of the PVC pipe are determined and set during sizing, reheating and cooling operations. A sizing operation holds the pipe in its proper dimensions during cooling of the material. The process is accomplished by drawing the hot material from the extruder die 120 through a sizing sleeve 130 upstream of a cooling tank 135. Sizing may be accomplished by using either vacuum or pressure. By way of example, in a vacuum sizing system, hot extrudate is drawn through a sizing tube 130 or rings while its surface is cooled enough to maintain proper dimensions and a circular form. The outside surface of the pipe may held against the sizing sleeve by vacuum or negative pressure.

After the pipe exits the vacuum sizing tank 130, it is moved through one or more spray or immersion cooling tanks 135. Various methods of cooling may be utilized to remove residual heat from the pipe. The system may use either total immersion or spray cooling, though spray cooling is usually applied to large diameter pipe where total immersion would be inconvenient.

Cooling water temperatures may be in the range of 40° to 55° F. The cooling tank 135 may contain annealing zones to minimize residual stresses by allowing heat contained within the inner pipe wall to radiate outward and anneal the entire pipe wall. The total length of the cooling bath must be adequate to cool the pipe below its glass transition temperature (t_{g}), e.g., below about 175° F. or whatever the t_{g} is for the particular pipe, in order to set an initial unexpanded diameter. In an exemplary implementation, the pipe is cooled to about 150° F. to 120° F. to continue processing.

As drawn through the cooling tank 135, the pipe solidifies from the outside of the wall to the inside of the wall. To cool to a state to continue processing, heat energy stored within the wall of the product is transferred to the water of the cooling tank on the outside of the product. The thinner the wall of the final product, the faster it will cool to the desired temperature. The heavier the wall of the product, the slower it will transfer heat and cool to a uniform solid state. As a poor thermal conductor, the plastic absorbs and relinquishes heat fairly slowly.

In some embodiments, a thermal conductivity of the resin is a fixed value, wherefore heat will only be transferred at given rate. In such embodiments, decreasing a temperature of the cooling water in the cooling tank 135will not increase the thermal energy transfer rate.

After emerging from the cooling tank 135, the PVC pipe may be reheated in reheater 140. The reheater 140 contains one or more heating elements configured to raise the temperature of the pipe to its glass transition temperature or slightly above the glass transition temperature. By way of example and not limitation, the temperature of the pipe may be increased to about 160° F. to 190° F. in the reheater 140.

PVC resin melts when its temperature becomes higher than its melting point and becomes softened and amorphous, but as it is gradually cooled from the softened and amorphous state its viscosity gradually increases, and it goes into a rubbery state and finally solidifies. The rubbery state lends softness and flexibility to the polymer. The temperature at the border from the rubbery state to the solid state (called the glass state) is called its “glass transition temperature.” The glass transition temperature is generally indicated as T_{g}. The glass transition temperature for PVC depends upon the cooling rate and molecular weight distribution and may be influenced by additives. Without plasticizer, the T_{g} for PVC is about 158° F. to 90° C. 194° F. For a plasticized PVC, the T_{g} may be about 125° F. to 60° C. 150° F. As a rule of thumb, most polymers will have a ratio of T_{g}/Tₘ of between 0.50 and 0.75, where Tₘ is the polymer's melting point (° K). A precise glass transition temperature may be determined for a particular PVC dry blend by differential scanning calorimetry.

Differential scanning calorimetry or DSC is a thermoanalytical technique in which the difference in the amount of heat required to increase the temperature of a sample and a reference is measured as a function of temperature. The reference has a well-defined heat capacity over the range of temperatures to be scanned. Both the sample and a reference are maintained at nearly the same temperature throughout a test. When the sample undergoes a physical transformation such as a phase transition, more or less heat will need to flow to it than the reference to maintain both at the same temperature. For example, as a PVC sample melts to a softened and amorphous it will require more heat flowing to the sample to increase its temperature at the same rate as the reference. This is due to the absorption of heat by the sample as it undergoes the endothermic phase transition from solid to softened and amorphous. By observing the difference in heat flow between the sample and reference, differential scanning calorimeters are able to measure the amount of heat absorbed or released during such transitions as well as during more subtle physical changes, such as glass transitions.

After emerging from the reheater 140, the pipe passes over an expander 145 (aka sizing mandrel) where its diameter is increased, e.g., doubled.

Referring now to FIG. 1A in some embodiments positive atmospheric pressure may be introduced inside of the PVC pipe during manufacture. In general, positive atmospheric pressure will serve to put uniform expansive pressure on the PVC pipe while the PVC pipe is in a heated state (elevated thermal energy). The uniform expansive pressure is conducive to forming PVC pipes of larger diameters than had been available in previously known manufacturing techniques.

For example as illustrated in FIG. 1A, in some embodiments, a plug may be inserted into the PVC Pipe following a vacuum chamber 130A and a cooling chamber 135A. The first plug 136 may be held in position via a restraint 138A. The restraint may include a chain, a cable, or other flexible type extension resistant article fixedly attached to a point along the manufacturing line. Other embodiments, may include a restraint comprised of a rigid or semi rigid rod, such as a steel rod, or a carbon fiber rod. The rod may also be fixedly attached to appoint along the line.

The First Plug 136 allows for a positive atmospheric pressure to be provided into the PVC pipe downstream of the First Plug 136 and prevents the positive atmospheric pressure from backing up into the pipe in the cooling chamber 135A. In preferred embodiments, the positive atmospheric pressure is present while the PVC pipe is in a heater 142. The positive atmospheric pressure may be supplied, for example via air or other gas into the interior of the PVC pipe. Some preferred embodiments include pumping an inert gas into the interior of the PVC pipe. The inert gas may include, for example, nitrogen.

A Second Plug 139 may include an expansion plug and the positive atmospheric pressure interior to the PVC pipe may help the PVC pile to uniformly expand over the expansion plug 139, even though the expansion plug is a high diameter plug as compared to previously known processes. The second lug may also be held in place via a restraint 138B.

Third plug may include an air seal plug for maintaining the positive atmospheric pressure within the PVC pipe and be held in place via a third restraining mechanism 138C.

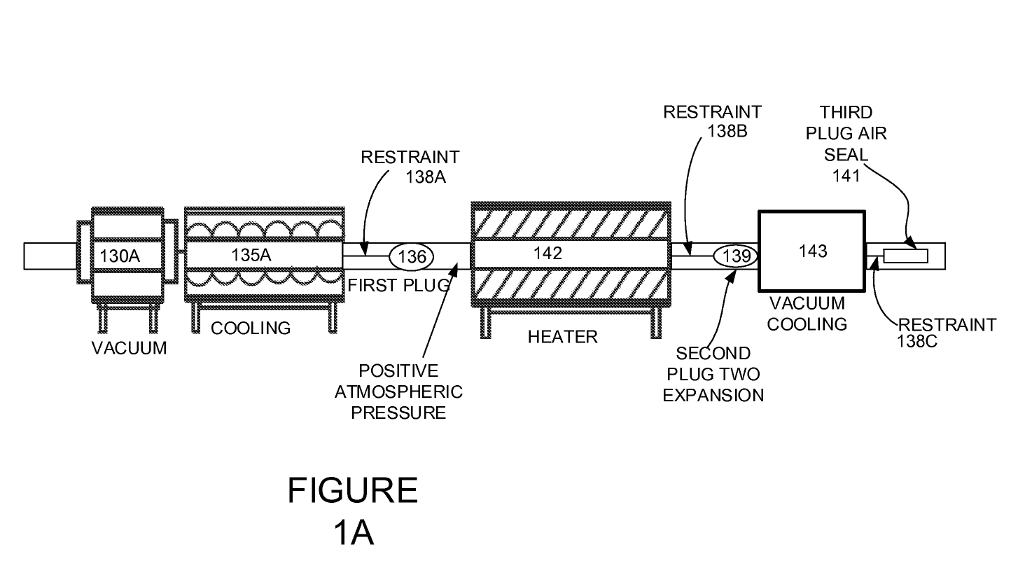

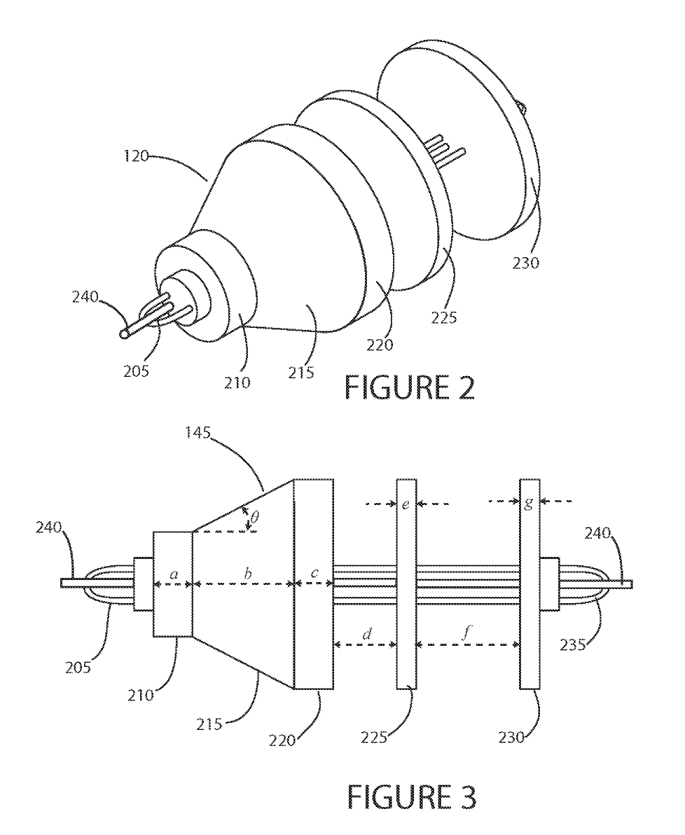

Referring now to FIG. 2 and FIG. 3, the expander 145 includes a first mandrel 210 having a diameter about equal to the inner diameter of the unexpanded pipe. The expander includes a second mandrel 220 having a diameter about equal to the inner diameter of the expanded pipe. The expanded diameter is about double the unexpanded diameter. A frustum 215 provides a transition between the first and second mandrel 210, 220. A plurality of (e.g., 2) discs 225, 230 are provided downstream of the second mandrel 220. A pair of couplings 205, 235 allow connection of the expander between the extruder die 120 and downstream components (i.e., cooling station 150). The couplings 205, 235 may be connected to upstream and downstream components by chains. Each disc 225, 230, has a diameter that is about the same as the diameter of the second mandrel 220. Pressure or a vacuum may hold the inner side of the pipe against the mandrels 210, 220 and discs 225, 230 for sizing. Exemplary, nonlimiting, dimensions for the measurements illustrated in FIG. 3 are a=1.5 in., b=4.5 in., c=1.5 in., d=1.5 in., e=0.75 in., f=3.0 in., g=0.75 in., with θ=28.8° and the diameter of the first mandrel being 4 in. and the diameter of the second mandrel 220 and each disc 225, 230 being 8 in. Having an angle θ of 30° or less, the frustum provides a gradual transition from the unexpanded to the expanded diameters.

The expanded diameter may be double the unexpanded diameter. The pylon diameter will be between the expanded diameter and the unexpanded diameter. In a preferred implementation, the pylon diameter is about midway between the expanded diameter and the unexpanded diameter.

Optionally, a continuous or intermittent coating of a heat sensitive adhesive may be applied to the inner wall of the extruded pipe after extrusion and expansion, so that when the pipe is heat shrunk to take the shape of the substrate (e.g., pylon) the adhesive creates a bond between the substrate and the PVC pipe.

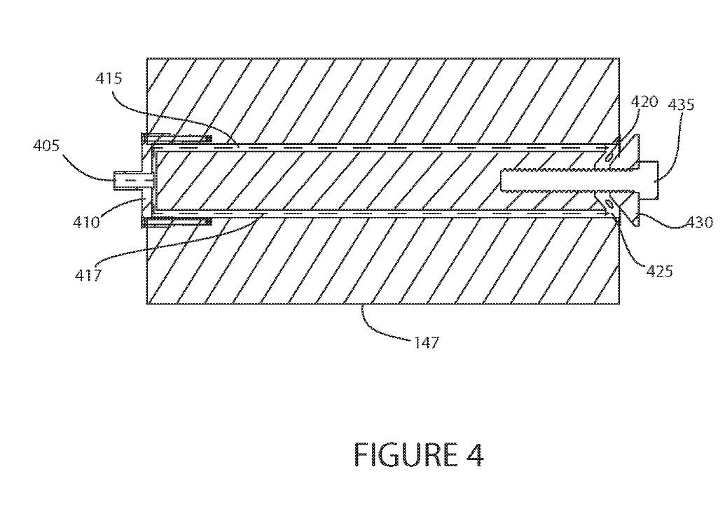

By way of example and not unclaimed limitation, an adhesive applicator 147 may be provided downstream of the sizing mandrel 145. As the expanded pipe emerges from the sizing mandrel 145, hot melt adhesive is applied to the inner wall of the pipe. As conceptually illustrated in FIG. 4, an applicator 147 may include a supply port 405, through which hot melt adhesive is supplied via supply line 240. The source of the hot melt adhesive is the heated receptacle 115 using a gear pump. The hot melt adhesive may flow through a heat resistant nylon tube 240 that passes through the die spider located in the mid region of the extruder die 120 and continues to connect with the sizing mandrel 145 and subsequently to the hot melt adhesive applicator 147 where the hot melt is evenly sprayed on the interior wall of the blown (i.e., expanded) pipe. The supply port may be fluidly coupled to a manifold 410 which feeds a plurality of channels, two of which 415, 417 are shown in the section view of the applicator 147 in FIG. 4. The channels 415, 417 define hot melt flow paths through applicator 147. An exit port 420, 425, is provided for each channel 415, 417. The exit ports 420, 425 emit hot melt adhesive along the inner sides of the pipe as it passes over the applicator 147. The hot melt adhesive flows from the exit ports 420, 425 through the space defined by the frustum cap 430 and the adjustment bolt 435. The space may be adjustable by tightening or loosening adjustment bolt 435.

After the reheated expanded pipe emerges from the expander 145, it enters another cooling tank 150, i.e., another spray or immersion cooling tank. The cooling tank 150 cools the pipe below its glass transition temperature (t_{g}) in order to set an expanded diameter. In an exemplary implementation, the pipe is cooled to below the t_{g}.

As the pipe emerges from the cooling tank 150, it has a diameter referred to herein as the expanded diameter. This diameter may be, for example, about eight inches. During heat shrinking, the diameter of the pipe will shrink from the expanded diameter towards the unexpanded diameter. This expanded diameter should be set to be greater than the diameter of the substrate.

The pipe is not limited to a structure having a circular cross section. Structures having non-circular cross section shapes (e.g., rectangular) may be produced in accordance with the principles of the invention. Thus, for examples, pipes having rectangular cross section shapes may encapsulate lumber and ties having rectangular cross section shapes. Additionally, pipes having shapes that differ from the shape of the substrate (e.g., a circular cross section pipe over a rectangular cross section substrate) may encapsulate the substrate. The heat shrinking action is sufficient to form a tight seal.

Pullers 137, 155 provide the necessary forces to pull the pipe through the entire post extrusion operation. The pullers also maintain the proper wall thickness control by providing a constant pulling rate. The first puller 137 controls the wall thickness of the pre-expanded pipe and prevents the second puller 155 from influencing the pipe as it is drawn from the die. The second puller 155 controls the wall thickness of the expanded pipe. The rate at which the pipe is pulled, at least in part, determines the wall thickness of the finished pipe. Increasing the puller speed at a constant screw speed may reduce the wall thickness, while reducing the puller speed at the same screw speed may increase wall thickness. The two pullers may be electronically controlled and linked to precisely control the wall thickness of the expanded pipe.

The pipe is then cut by a cutter 160 into specified lengths for bundling, storage and shipping. The pipe may be cut into any desired lengths (e.g., 8, 10, 12, or 16 feet). Lengths that are not greater than 40 to 50 feet can be shipped easily by rail or truck. Bundling provides ease of handling and safety during loading and unloading.

The extrusion line may have one or more printing stations for printing notations on the pipe. An on-line gauging system may measure the product's outer diameter with a laser-based scanner. Such laser gauging systems have a very high measurement accuracy and a very high scanning rate for measurement averaging. Such gauging scanners are usually placed in the extrusion line after cooling and before the belt puller.

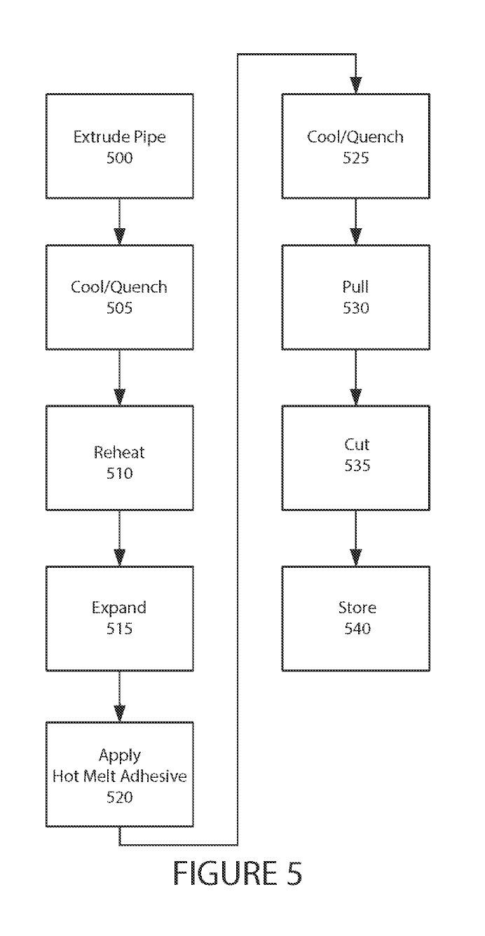

Referring now to FIG. 5, a high-level flowchart for an exemplary method of producing a seamless heat shrinkable sleeve according to principles of the invention is provided. In step 500, pipe is extruded from the die. The extruded pipe is then sized and cooled to below its glass transition temperature, as in step 505. After cooling, the pipe is reheated to the glass transition temperature or slightly above that temperature, as in step 510. The reheated pipe is then expanded, as in step 515. In some preferred embodiments, expansion increases the diameter by about a factor of 2. Optionally, hot melt adhesive is applied to the inner surface of the pipe after the expansion process, as in step 520. The expanded reheated pipe may then cooled to below its glass transition temperature, as in step 525. The pipe may be continuously pulled at a constant rate through the extrusion line stations at which the foregoing steps are performed, as in step 530. The pipe is then cut, as in step 535, for bundling, storage and shipping, as in step 540.

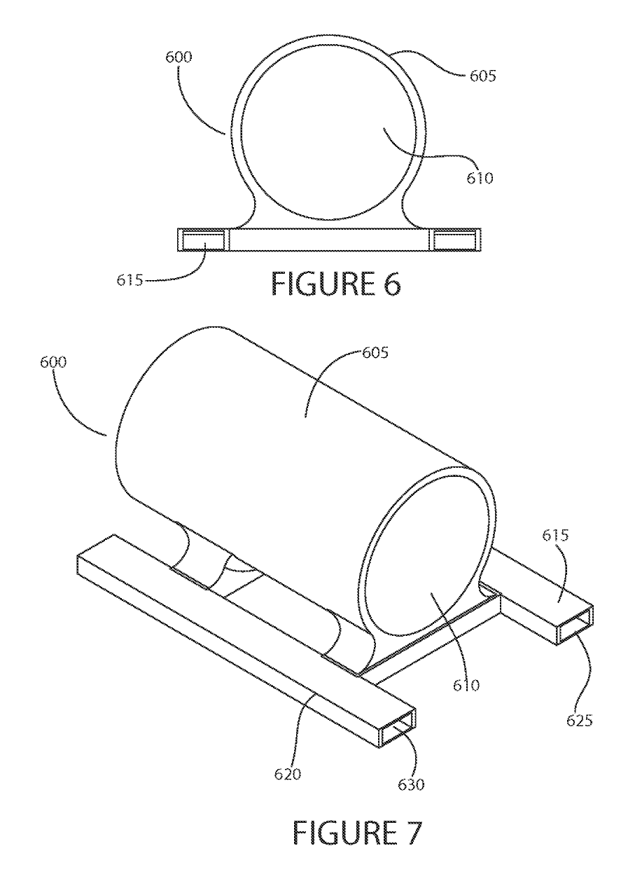

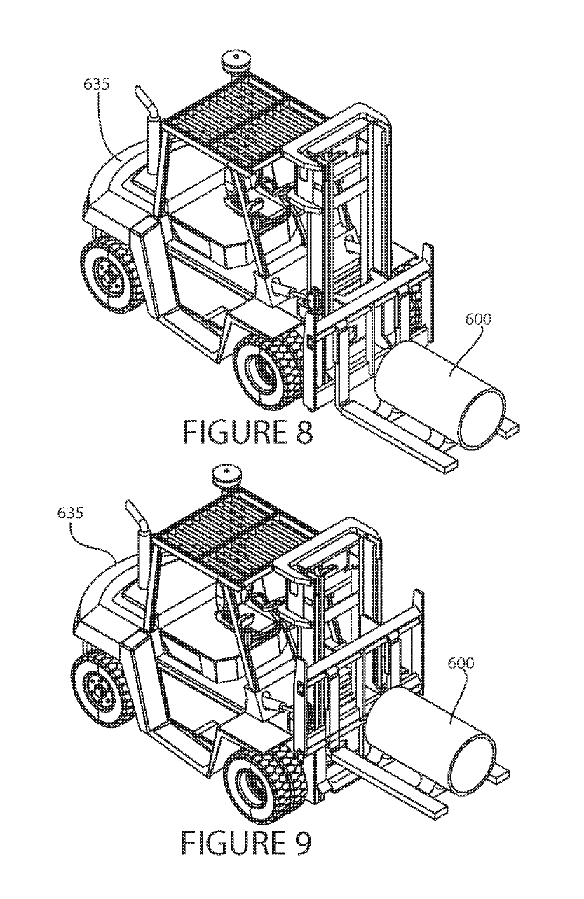

Referring now to FIGS. 6 and 7, an exemplary pylon holder 600 for a forklift according to principles of the invention is shown. The pylon holder 600 includes a hollow cylindrical tube 605 having an inner diameter that is greater than the diameter of the wood pylon to be lifted. An end of the pylon is inserted into the hollow space 610. A pair of fork sleeves 615, 620 are provided for receiving the forks of a forklift. The fork sleeves 615, 620, include compartments 625, 630 for receiving forks of a forklift. The tube 605 may be positioned above or below the forks. The pylon holder 600 is shown in a lowered position on a forklift truck in FIG. 8 and in a raised position in FIG. 9.

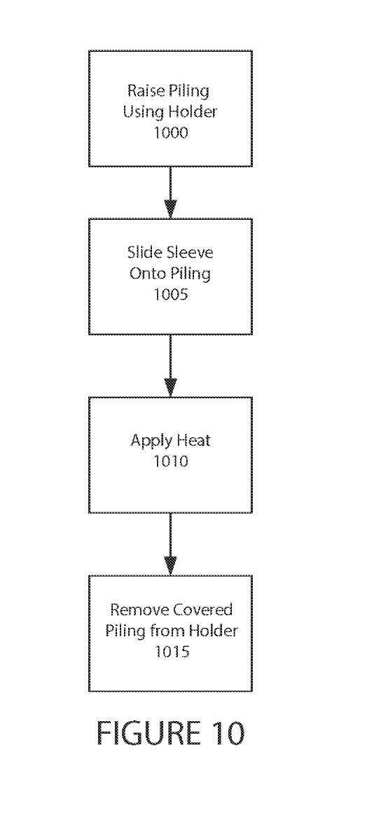

The pylon holder 600 is used to lift a pylon by an end, so that the extruded pipe may be slid onto the pylon from the opposite end. FIG. 10 provides a flowchart for an exemplary method of applying a seamless heat shrinkable sleeve to a pylon according to principles of the invention. In step 1000, the pylon is raised, such as by using the pylon holder 600 on a forklift. Then the pipe (i.e., sleeve) is slid onto the pylon, as in step 1005. The sleeve does not have to cover the entire pylon. The portion of the pylon below the seabed does not have to be covered. The portion of the pylon consistently above the sealevel does not have to be covered. The remaining portion of the pylon should be covered. As the sleeve diameter is greater than the pylon diameter, the sleeve should freely slide on the pylon.

After the sleeve is correctly positioned over the portions of the pylon to be protected, it is shrunk by applying heat, as in step 1010. Sufficient heat should be applied to raise the temperature of the pylon to its glass transition temperature or slightly higher. In general as the substrate is positioned within the inner diameter of the PVC pipe, the thermally unstable expanded diameter is heated and the PVC pipe tries to return to the thermally stable unexpanded diameter causing the PVC pipe to shrink around the substrate as the substrate prevents the PVC pipe from returning fully to the stable unexpanded diameter.

The heat may be applied using one or more torches, heat lamps, steam and resistive heating elements. The heat source may be moved along the periphery of the sleeve to heat all portions of the sleeve as evenly as reasonably possible. This reheat causes the pipe to regress towards its original unexpanded extruded form, toward the unexpanded diameter.

After heat shrinking, the covered pylon may be allowed to cool briefly and then removed from the holder, as in step 1015. After removal, the protected pylon may be deployed for use.

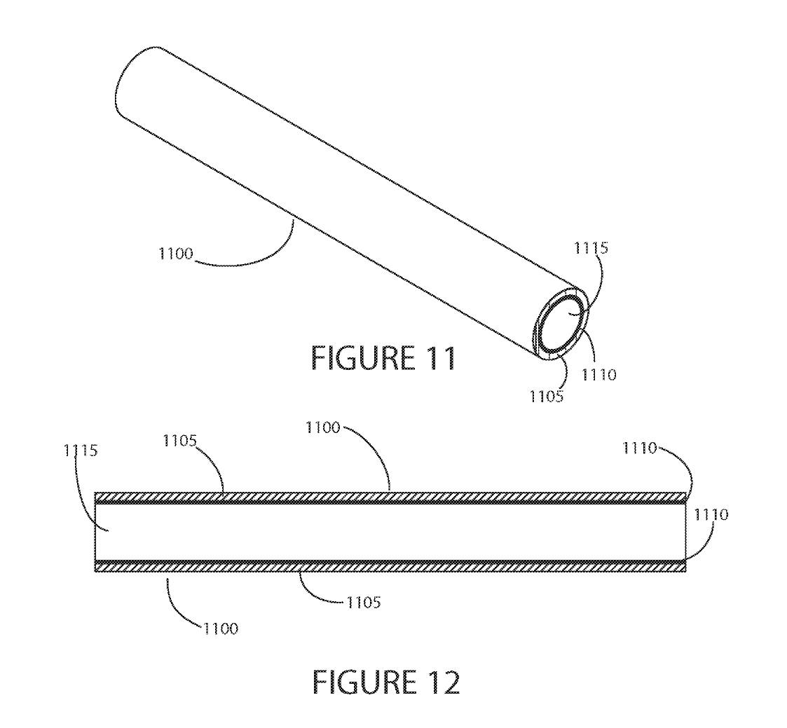

Referring now to FIG. 11 and FIG. 12 conceptual illustration of an exemplary extruded heat shrink protective seamless pylon sleeve or PVC pipe 1100 is shown, according to principles of the invention. In the exemplary illustration the sleeve includes an outer PVC layer 1105 and an inner hot melt adhesive layer 1110, adhesives other than a hot melt adhesive may also be used. The channel 1115 defined by the PVC layer 1105 and the inner hot melt adhesive layer 1110 is sized to receive a wood substrate (i.e., a wood pylon).

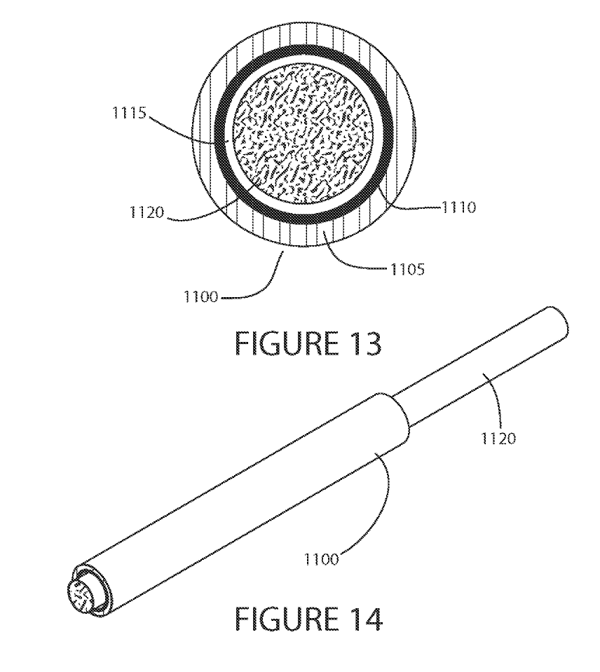

In FIGS. 13 and 14 views of the exemplary extruded heat shrink protective seamless pylon sleeve with a surrounded pylon and a gap between the pylon and sleeve according to principles of the invention are provided. A substrate, such as for example a wood substrate 1120 (e.g., a pylon) is shown in the channel space 1115. The diameter of the channel 1115 is greater than the diameter of the pylon 1120, when the PVC pipe 1100 is in a thermally unstable expanded state, or preshrunk state.

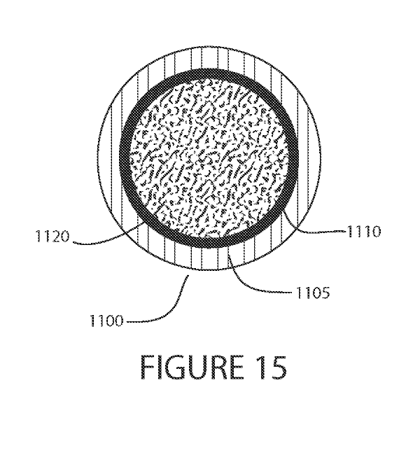

In FIG. 15, the PVC pipe 1100 is shown in a thermally stable unexpanded state, after heat has been applied. The pipe 1100 is in close proximity to the underlying substrate, in this case an adhesive layer 1110 of the pipe 1100, intimately contacts and bonds with the substrate, leaving no space there between. In an embodiment without the adhesive layer 1110, the inner surface of the PVC layer 1105 intimately contacts and abuts the underlying substrate, leaving no appreciable space there between.

The resulting product is a pylon with a seamless PVC shrink-wrapped sleeve covering at least a portion of the pylon. By omitting seams, the product avoids risk of delamination and gapping that may allow intrusion by water and/or organisms.

A fungicide may be included in one or both of the PVC dry blend and the hot melt adhesive. Any fungicide suitable for extrusion processing and marine applications may be utilized within the scope of the present invention. Alternatively, a fungicide coating may be applied to the surfaces of the pipe after manufacturing.

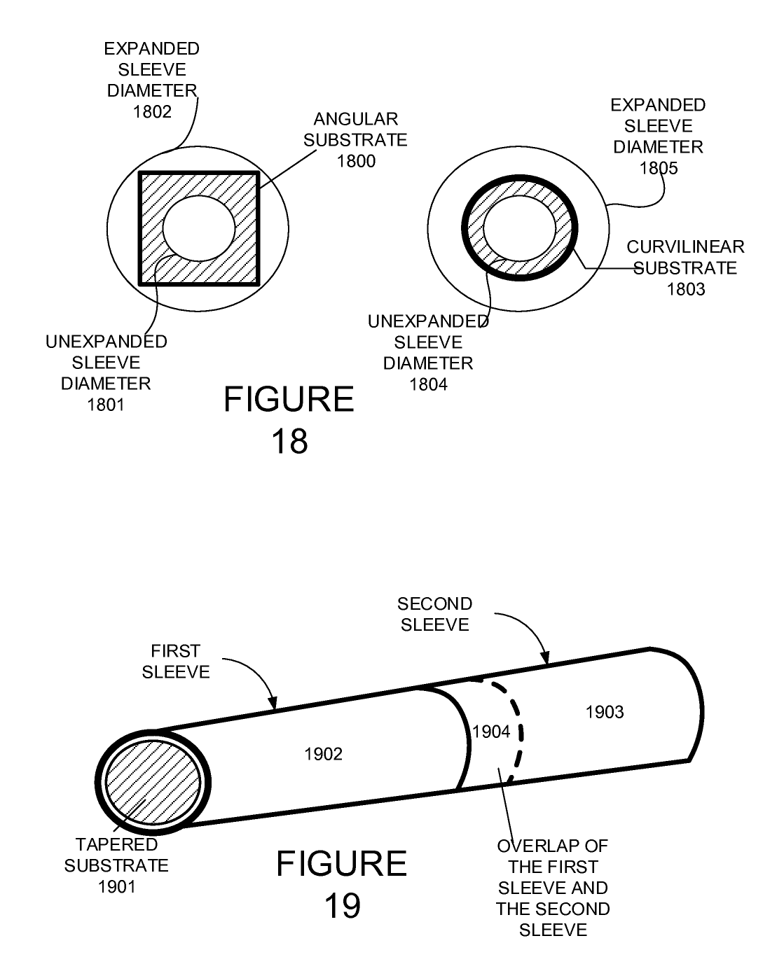

Referring now to FIG. 18 a cross section of an angular substrate 1800 is illustrated with a generally square cross section. The angular cross section is shown concentrically with a thermally stable unexpanded sleeve (PVC pipe) diameter 1801 and a thermally unstable expanded diameter 1802. The thermally unstable unexpanded sleeve diameter 1802 is large enough for the PVC pipe to slip over the angular substrate and the thermally stable unexpanded diameter 1801 is small enough such that when a PVC pipe around the angular substrate is heated, the PVC pipe will shrink and conform to the shape of the angular substrate 1800 essentially tightly coating the angular substrate 1800.

Similarly, a cross section of a curvilinear substrate 1803 is illustrated with a generally round cross section. The curvilinear cross section is shown concentrically with a thermally stable unexpanded sleeve (PVC pipe) diameter 1804 and a thermally unstable expanded diameter 1805. The thermally unstable unexpanded sleeve diameter 1805 is large enough for the PVC pipe to slip over the curvilinear substrate and the thermally stable unexpanded diameter 1804 is small enough such that when a PVC pipe around the curvilinear substrate is heated, the PVC pipe will shrink and conform to the shape of the curvilinear substrate 1800 essentially tightly coating the curvilinear substrate 1803.

Referring now to FIG. 19, a tapered substrate is illustrated. A significant number of pylon substrates are derived from trees, as such the pylons do not always include a constant diameter over the length of the pylon substrate1901. In such embodiments, a fist sleeve of PVC pipe 1902 and a second sleeve of PVC pipe 1903 may be utilized to span the pylon substrate from linear end to end. The first sleeve of PVC pipe 1902 may include a smaller stable unexpanded diameter than the second sleeve of PVC pipe 1903, wherein the first sleeve is able to shrink to a diameter suitable for encapsulating a more narrow portion of the tapered substrate 1901 and the second sleeve may include a larger expanded diameter that enables the second sleeve of PVC pipe 1903 to fit over the larger diameter portion of the tapered substrate 1901.

Accordingly, implementations of the present invention may include a substrate including a wooden pylon with a diameter of any given cross section of between about six inches and fourteen inches. Similarly, implementations may include a timber beam with an angular shape such as a square or a rectangle, with each side of the timber beam between about six inches and twelve inches,

As illustrated, in another aspect, an overlap of the first sleeve and the second sleeve allows for the entire tapered, or frustum shaped substrate to be encapsulated with PVC pipe 1902-1903.

Substrates to be protected by the pipe may comprise wood pylon, dimensional lumber, railroad ties, fence posts, elongated metal structures such as steel beams, columns and posts, and the like. Any elongated structure having a diameter or maximum width that is less than the inner diameter or width of the pipe may be protected by the pipe. The pipe does not have to cover the entirety of the substrate. Rather, only the portion requiring protection may be covered. In some cases, the entirety of the substrate may require protection. In other cases, only a portion (e.g., a submerged portion) may require protection.

The pipe is not limited to a circular cross section. Other shapes, including but not limited to rectangular, I-beam, L, U, and other curvaceous or polygonal shapes may be produced within the scope of the invention.

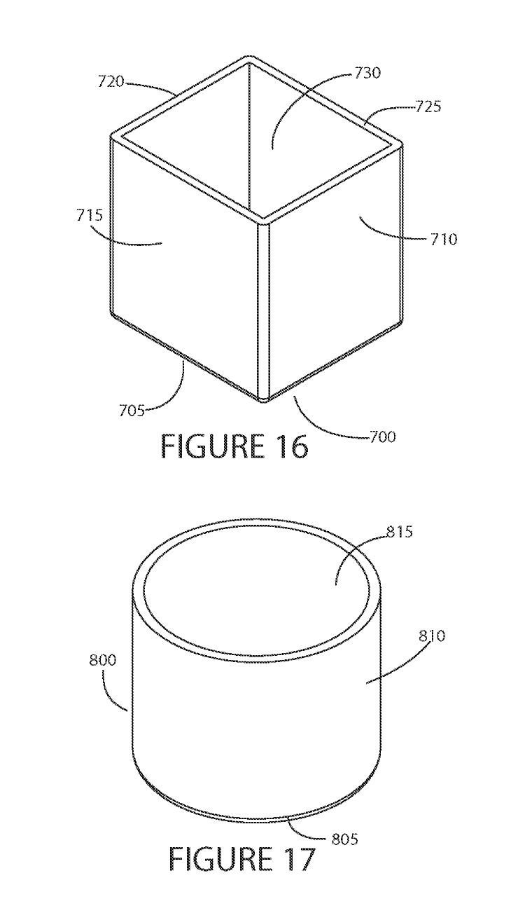

With reference to FIG. 16, a perspective view of a heat shrink rectangular end cap 700 for use with an exemplary extruded protective seamless pylon sleeve according to principles of the invention is conceptually illustrated. The cap includes an end wall 705 and four flanges 710, 715, 720, 725 defining a compartment 730 into which the end of a pylon, tie, beam or the like may be inserted. The cap 700 may be comprised of a PVC compound. The cap 700 is molded to its unexpanded dimensions, cooled, then reheated to about the glass transition temperature (t_{g}) and stretched to the expanded dimensions, and then cooled. Upon reheating after installation, the cap 700 will shrink towards its unexpanded dimensions. The cap 700 is sized such that the end of the substrate has dimensions between the unexpanded and expanded dimensions.

With reference to FIG. 17, a perspective view of a heat shrink circular end cap 800 for use with an exemplary extruded protective seamless pylon sleeve according to principles of the invention is conceptually illustrated. The cap includes an end wall 805 and a continuous cylindrical flange 810 defining a compartment 815 into which the end of a pylon, tie, beam or the like may be inserted. The cap 800 may be comprised of a PVC compound. The cap 800 is molded to its unexpanded dimensions, cooled, then reheated to about the glass transition temperature (t_{g}) and stretched to the expanded dimensions, and then cooled. Upon reheating after installation, the cap 800 will shrink towards its unexpanded dimensions. The cap 800 is sized such that the end of the substrate has dimensions between the unexpanded and expanded dimensions.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A method of providing a substrate with a protective coating, said method comprising steps of:
heating a polyvinylchloride (PVC) dry blend until a melt is formed;
extruding the melt through a die to form a PVC pipe having an outer surface, an inner surface and a thermally stable unexpanded inner diameter greater than two inches;
cooling the extruded PVC pipe to a first temperature below a glass transition temperature for the PVC pipe;
after cooling the extruded PVC pipe to the first temperature below the glass transition temperature, providing a positive atmospheric pressure against the inner surface of the PVC pipe in an outward direction;
heating the extruded PVC pipe to a second temperature equal to or greater than the glass transition temperature for the PVC pipe;
after heating the extruded PVC pipe to the second temperature, expanding the PVC pipe from a thermally stable unexpanded inner diameter to a thermally unstable expanded inner diameter of about four inches or greater;
after expanding the PVC pipe, cooling the PVC pipe to a second temperature below the glass transition temperature for the PVC pipe while the PVC pipe maintains a diameter of about four inches or greater;
placing the PVC pipe over the substrate so that the substrate is positioned within the inner diameter of the expanded PVC pipe, the substrate having a maximum width that is greater than the unexpanded inner diameter and less than the expanded inner diameter; and
heating the PVC pipe while the substrate is positioned within the inner diameter of the PVC pipe to a third temperature equal to or greater than the glass transition temperature for the PVC pipe causing a shape of the inner surface of the PVC pipe to form to the shape of the substrate and remain proximate to the substrate thereby encapsulating at least a portion of the substrate with a protective coating comprising the PVC pipe.

2. The method of protecting a substrate according to claim 1, wherein said unexpanded inner diameter comprises about one quarter to three quarters of the expanded inner diameter.

3. The method of protecting a substrate according to claim 1, said step of extruding the melt through a die to form a seamless PVC pipe having an unexpanded inner diameter greater than two inches further comprising the step of coextruding a hot melt adhesive onto at least a portion of the inner surface of the PVC pipe.

4. The method of protecting a substrate according to claim 1, further comprising, after the step of expanding the PVC pipe, the step of applying a hot melt adhesive onto the inner surface of the PVC pipe.

5. The method of protecting a substrate according to claim 1, further comprising the steps of:
providing a positive atmospheric pressure against the inner diameter of the PVC pipe; and
passing the PVC pipe over a mandrel having a first cylindrical section with a first mandrel diameter about equal to the unexpanded inner diameter, and a second cylindrical section with a second mandrel diameter about equal to the expanded inner diameter, and a conical frustum disposed between and coupling the first cylindrical section to the second cylindrical section, said conical frustum, first cylindrical section and second cylindrical section being concentric.

6. The method of protecting a substrate according to claim 5, said mandrel further comprising a plurality of sizing discs, each of the plurality of sizing discs having a disc diameter about equal to the expanded inner diameter, and each of the plurality of sizing discs being concentric with the second cylindrical section and spaced apart from each other and the second cylindrical section.

7. The method of protecting a substrate according to claim 5, further comprising maintaining a negative pressure at the mandrel against the outside surface of the PVC pipe as the PVC pipe passes over a mandrel.

8. The method of protecting a substrate according to claim 1, said PVC dry blend including a fungicide.

9. The method of protecting a substrate according to claim 4, said hot melt adhesive including a fungicide.

10. The method of protecting a substrate according to claim 1, further comprising a step of cutting the PVC pipe to a determined length, after the step of cooling the PVC pipe to the second temperature below the glass transition temperature for the PVC pipe.

11. The method of protecting a substrate according to claim 1, wherein the substrate comprised a curvilinear wooden pylon with a diameter at any given cross section of between about six inches and fourteen inches.

12. The method of protecting a substrate according to claim 1, wherein the substrate comprised an angular timber beam with each side comprising between about six inches and twelve inches.

13. The method of protecting a substrate according to claim 11, wherein the step of sliding the PVC pipe over at least a portion of the substrate further comprises lifting the substrate with a forklift.

14. The method of protecting a substrate according to claim 13, wherein the step of lifting the substrate with a forklift, further comprises equipping forks of the forklift with a tubular holder, said tubular holder having an inner diameter greater than the expanded diameter of the PVC pipe, and said substrate being held in the tubular holder.

15. A substrate assembly comprising:
a heat shrinkable seamless PVC pipe wherein said PVC pipe has been cooled after extrusion and reheated to a glass transition temperature of the PVC pipe after cooling, and expanded to a thermally unstable expanded diameter after reheating, said expanded diameter comprising an inner diameter of six or more inches;
a linear substrate placed within the inner diameter of the PVC pipe;
said PVC pipe covering at least a portion of a linear substrate;
said PVC pipe being shrunk onto the linear substrate by application of thermal energy to the PVC pipe, the application of thermal energy to the PVC pipe causing the PVC pipe to seek to revert to a thermally stable diameter less than four inches and thereby encapsulate at least a portion of the substrate.

16. The heat shrinkable seamless PVC pipe for protecting a substrate according to claim 15, said PVC pipe comprising about 1 to 5% by weight epoxidized soy bean oil and about 0.1 to 1% by weight fungicide.

17. The heat shrinkable seamless PVC pipe for protecting a substrate according to claim 15, further comprising an inner layer of hot melt adhesive.

18. The heat shrinkable seamless PVC pipe for protecting a substrate according to claim 15, further comprising an inner layer of hot melt adhesive.

19. The heat shrinkable seamless PVC pipe for protecting a substrate according to claim 15, further comprising an inner layer of hot melt adhesive having a viscosity at 350° F. of up to 15,000 centipoise.

20. The heat shrinkable seamless PVC pipe for protecting a substrate according to claim 19, said hot melt adhesive containing a fungicide.
